(19) United States
(12) Patent Application Publication
(10) Pub. No.: US 2015/0130251 A1
(43) Pub. Date: May 14, 2015

(54) SEAT ELASTIC SUPPORT STRUCTURE

(71) Applicant: HONDA MOTOR CO., LTD., Tokyo (JP)

(72) Inventors: Takashi Kondo, Haga-gun (JP); Shinobu Sato, Shioya-gun (JP); Hiroyuki Yasuda, Haga-gun (JP); Tomoyuki Honda, Haga-gun (JP); Naoyuki Saruwatari, Haga-gun (JP); Tomomi Kitsugi, Utsunomiya-shi (JP)

(21) Appl. No.: 14/400,387

(22) PCT Filed: Jun. 3, 2013
(86) PCT No.: PCT/JP2013/065362

§ 371 Date: Nov. 11, 2014

(30) Foreign Application Priority Data
Jul. 6, 2012 (JP) 2012-153028

(51) Int. Cl. B60N 2/50; B60N 2/54

(52) U.S. Cl. CPC B60N 2/502; B60N 2/542
USPC 297/451.3

(57) ABSTRACT

A seat elastic support structure includes: a slide adjuster; a foot member; and an elastic support body interposed between the slide adjuster and the foot member and having an outer tube member, an inner tube member arranged inside the outer tube member, and an elastic body interposed between the outer tube member and the inner tube member, wherein: an end portion on a (−X, −Z) side in an axis line direction of the inner tube member is in contact with the slide adjuster; the foot member is provided with a through hole (30) into which the outer tube member (51) is inserted; and an inner peripheral surface of the through hole and an outer peripheral surface of the outer tube member are joined to each other.

### TECHNICAL FIELD

The present invention relates to a seat elastic support structure.

Priority is claimed on Japanese Patent Application No. 2012-153028 filed on Jul. 6, 2012, the contents of which are incorporated herein by reference.

### BACKGROUND

In order to ensure good ride quality, a vehicle seat needs to be supported by a vehicle floor so as to avoid influences of vibration input from an engine in an idling state during stopping of the vehicle (hereinafter, referred to as “idling vibration”) and vibration input from a road surface during running of the vehicle (hereinafter, referred to as “running vibration”).

For example, Patent Document 1 discloses a vehicle seat leg (elastic support body): including a tube body and a support rod provided along a central axis of the tube body; having an upper end portion of the support rod joined to a seat frame on the seat side; having a lower edge portion of the tube body joined to a slide rail on the floor side; and including a rubber-like elastic body interposed between the tube body and the support rod.

Patent Document 1 discloses that, by the vibration of the vehicle, a share force is loaded on the rubber-like elastic body, and due to the viscoelastic property of the rubber-like elastic body, it is possible to mitigate vibration transmission from the tube body to the support rod, that is, vibration transmission from the floor side to the seat side and to improve the ride quality of the vehicle.

### RELATED ART DOCUMENTS

### Patent Documents

[Patent Document 1] Japanese Unexamined Patent Application, First Publication No. 2010-132178

### SUMMARY OF INVENTION

### Problems to be Solved by the Invention

However, in the seat elastic support structure according to Patent Document 1, there is a problem as below.

In the vehicle seat leg, the upper end portion of the support rod is joined to the seat frame on the seat side and the lower edge portion of the tube body is joined to the slide rail on the floor side, and the vehicle seat leg is arranged between the seat and the floor. Accordingly, the seat position becomes high depending on the length in the axis direction of the vehicle seat leg, and therefore there is a possibility that the layout flexibility of the seat is deteriorated.

An object of an aspect according to the present invention is to provide a seat elastic support structure capable of preventing the seat position from becoming high and capable of ensuring the layout flexibility of the seat.

### Means for Solving the Problem

In a seat elastic support structure according to an aspect of the present invention, the following configurations are employed in order to achieve the aforementioned object.

(1) A seat elastic support structure according to an aspect of the present invention includes: a floor member; a seat member facing the floor member; and an elastic support body interposed between the floor member and the seat member and having an outer tube member, an inner tube member arranged inside the outer tube member, and an elastic body interposed between the outer tube member and the inner tube member, wherein one end portion in an axis line direction of the inner tube member is in contact with a first member which is any one of the floor member and the seat member, a second member which is the other of the floor member and the seat member is provided with a through hole into which the outer tube member is inserted, and an inner peripheral surface of the through hole and an outer peripheral surface of the outer tube member are joined to each other.

According to the aspect of the above (1), the through hole of the second member and the outer peripheral surface of the outer tube member are joined to each other, and thereby it is possible to fix the second member at a more inward position than both end portions in the axis line direction of the elastic support body. Thus, unlike the related art in which one of both end portions in the axis line direction of the elastic support body is joined to the floor member and the other of both end portions is joined to the seat member, the seat position can be set without being restricted by the length in the axis line direction of the elastic support body. Accordingly, it is possible to prevent the seat position from becoming high, and therefore the layout flexibility of the seat can be ensured.

(2) In the aspect of the above (1), a fastening member used to fasten the inner tube member to the first member may be provided radially inside the inner tube member.

According to the aspect of the above (2), since the inner tube member is fastened to the first member by the fastening member, it is possible to fix the elastic support body to the first member with a simple structure. In addition, the fastening member is provided radially inside the inner tube member, and thereby it is possible to prevent the inner tube member from increasing in size radially outwardly, compared to a case where the fastening member is provided radially outwardly of the inner tube member. Accordingly, it is possible to prevent the elastic support body from increasing in size, and therefore the layout flexibility of the seat can be further ensured.

(3) In the aspect of the above (1) or (2), the other end portion in the axis line direction of the inner tube member may be provided with a flange unit which is greater than an inner diameter of the through hole.

According to the aspect of the above (3), even when a load is applied to the first member to which the inner tube member is fastened or the second member joined to the outer tube member, and the first member and the second member relatively move in a direction away from each other, the second member and the flange unit provided on the other end portion in the axis line direction of the inner tube member interfere. Accordingly, since the relative movement between the first member and the second member is restricted, and it is possible to prevent the second member from being detached from the outer tube member, it is possible to prevent that the floor member and the seat member are separated from each other.

### Advantage of the Invention

According to an aspect of the present invention, the through hole of the second member and the outer peripheral surface of the outer tube member are joined to each other, and thereby it is possible to fix the second member at a more inward position than both end portions in the axis line direction of the elastic support body. Thus, unlike the related art in which one of both end portions in the axis line direction of the elastic support body is joined to the floor member and the other of both end portions is joined to the seat member, the seat position can be set without being restricted by the length in the axis direction of the elastic support body. Accordingly, it is possible to prevent the seat position from becoming high, and therefore the layout flexibility of the seat can be ensured.

### BRIEF DESCRIPTION OF THE DRAWINGS

FIG. 1 is a perspective view of a seat supported by a seat elastic support structure.

FIG. 2 is an enlarged view of a seat support mechanism.

FIG. 3 is an exploded perspective view of the seat support mechanism.

FIG. 4 is a cross-sectional view along an A-A line of FIG. 2.

FIG. 5 is an explanation drawing of frequencies of a variety of vibration occurring in a vehicle.

FIG. 6 is an explanation drawing of another layout example of an elastic support body.

### DESCRIPTION OF THE EMBODIMENTS

Hereinafter, an embodiment of the present invention will be described with reference to the drawings.

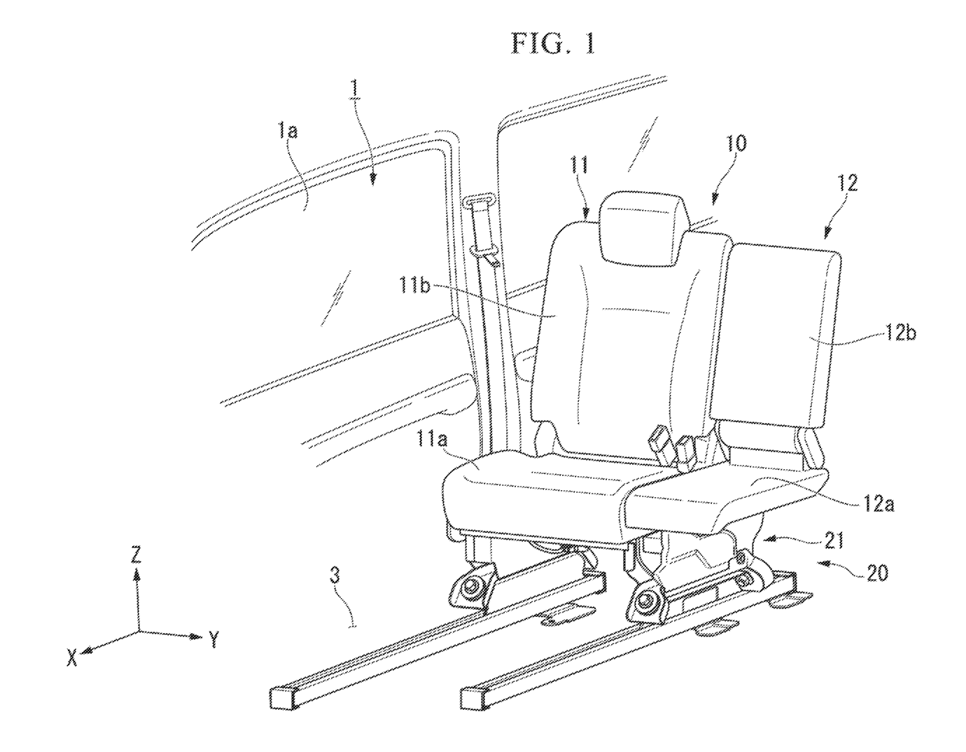

FIG. 1 is a perspective view of a seat 10 supported by a seat elastic support structure.

As shown in FIG. 1, a vehicle 1 is, for example, a minivan-type vehicle provided with three rows of seats (partly not shown) in a vehicle interior 1a. The embodiment is described using an example of an elastic support structure which is adopted for second row seats 10 (hereinafter, simply referred to as “seat 10”). In the following description, the front-rear direction of the vehicle 1 is defined as an X direction, the front side is defined as a +X side, and the rear side is defined as a −X side. The right-left direction of the vehicle 1 is defined as a Y direction, the left side is defined as a +Y side, and the right side is defined as a −Y side. The height direction of the vehicle 1 is defined as a Z direction, the upper side is defined as a +Z side, and the lower side is defined as a −Z side.

The seat 10 is configured by a right seat 11, a center seat 12, and a left seat (not shown). The right seat 11, the center seat 12, and the left seat are each fixed to a vehicle body floor 3 via a seat support mechanism 20.

Note that, a support structure of the right seat 11 and the center seat 12 to the vehicle body floor 3 is the same as a support structure of the left seat to the vehicle body floor 3. Accordingly, in the following description, the support structure of the right seat 11 and the center seat 12 to the vehicle body floor 3 is described, and a description of the support structure of the left seat to the vehicle body floor 3 is omitted.

The right seat 11 is provided with a seat cushion 11a that supports a hip portion and a thigh portion of a user (not shown) and a seat back 11b that supports a waist portion and a back portion of the user. The center seat 12 is provided with a seat cushion 12a that supports the hip portion and the thigh portion of the user and a seat back 12b that supports the waist portion and the back portion of the user.

The seat back 11b is rotatably joined to the seat cushion 11a via a reclining mechanism (now shown). The seat back 12b is rotatably joined to the seat cushion 12a via a reclining mechanism.

The seat support mechanism 20 is provided on the −Z side of the seat cushions 11a, 12a. The seat support mechanism 20 is fixed to the seat cushions 11a, 12a and integrally supports the right seat 11 and the center seat 12.

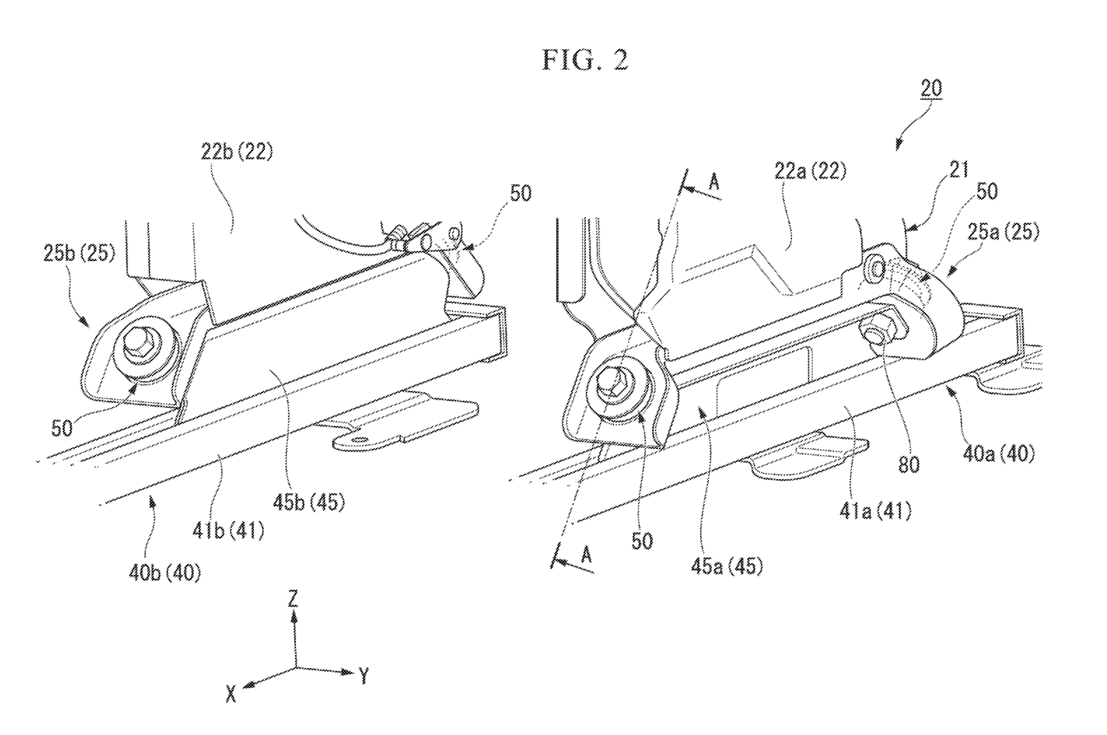

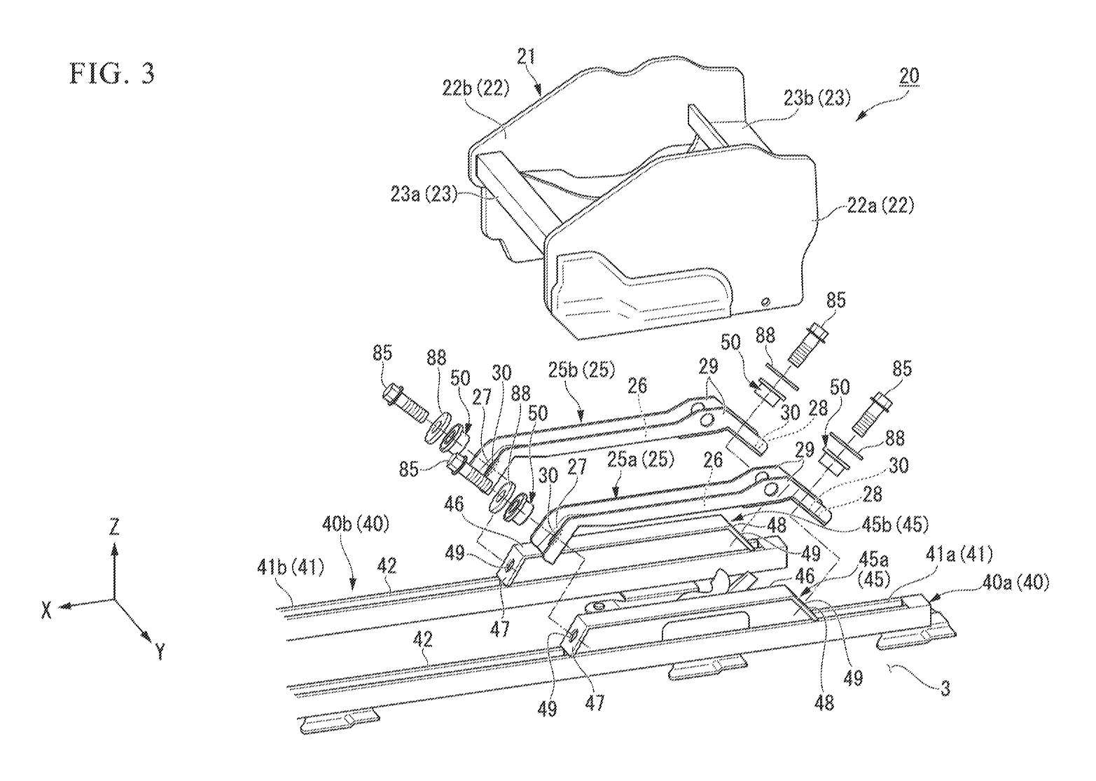

FIG. 2 is an enlarged view of the seat support mechanism 20. FIG. 3 is an exploded perspective view of the seat support mechanism 20. In FIG. 2 and FIG. 3, for easy understanding, the seat 10 (refer to FIG. 1) is omitted.

As shown in FIG. 2, the seat support mechanism 20 is configured by a pair of slide mechanisms 40 (40a, 40b) provided with a seat base 21, a pair of foot members 25 (25a, 25b) (seat member, second member, the other member), a lower rail 41 (41a, 41b), and a slide adjuster 45 (45a, 45b) (floor member, first member, one member), and an elastic support body 50 interposed between the foot member 25 and the slide adjuster 45. Hereinafter, each of the components which constitute the seat support mechanism 20, and the elastic support structure of the seat 10 in which the elastic support body 50 is interposed between the foot member 25 and the slide adjuster 45 are described in detail.

As shown in FIG. 3, the seat base 21 is configured by a pair of support plates 22 (22a, 22b) each provided on the +Y side and the −Y side, and a pair of connection members 23 (23a, 23b) each provided on the +X side and the −side and each connecting the pair of support plates 22a, 22b. The seat base 21 is formed in a substantially rectangular frame shape in a view from the Z direction.

Each of the pair of support plates 22a, 22b has a predetermined thickness in the Y direction, and is a member formed substantially parallel to an X-Z plane and having a substantially flat plate shape. The support plates 22a, 22b are arranged so as to face to each other.

Each of the pair of connection members 23a, 23b is, for example, a hollow square pipe member extending in the Y direction. The pair of connection members 23a, 23b are each arranged inside the pair of support plates 22a, 22b and each connect the pair of support plates 22a, 22b.

As shown in FIG. 1, the seat base 21 is arranged on the −Z side of the right seat 11 and the center seat 12. The seat base 21 integrally supports the seat cushion 11a of the right seat 11 and the seat cushion 12a of the center seat 12 in a state where the seat cushion 11a and the seat cushion 12a are connected to each other in the Y direction.

### (Foot Member)

As shown in FIG. 2, each of the pair of foot members 25a, 25b is provided on the −Z side of the pair of support plates 22a, 22b constituting the seat base 21.

Note that, one of the pair of foot members 25a, 25b is formed in substantially the same shape as that of the other. Accordingly, in the following description, the foot member 25a provided on the +Y side is described, and a detailed description of the foot member 25b provided on the −Y side is omitted.

The foot member 25a is a member formed of, for example, a metal such as iron and is formed by press working. As shown in FIG. 3, the foot member 25a is formed in substantially an arch shape opening on the −Z side in a view from the Y direction. The foot member 25a is formed by a member body unit 26 extending along the X direction, a +X-side fixing unit 27 provided at an end portion on the +X side, and a −X-side fixing unit 28 provided at an end portion on the −X side.

The member body unit 26 is formed to have a length in the X direction which is substantially the same as a length in the X direction of the support plate 22a. The member body unit 26 is fixed to the −Z side of the support plate 22a, for example, by a bolt (not shown) or the like.

The +X-side fixing unit 27 and the −X-side fixing unit 28 each have a shape of an inclined surface inclining in the −Z direction. The +X-side fixing unit 27 and the −X-side fixing unit 28 are formed such that the distance between the +X-side fixing unit 27 and the −X-side fixing unit 28 is gradually greater from the +Z side toward the −Z side.

One of a pair of reinforcement ribs 29 facing each other is provided to stand in the Z direction on each of both sides in the Y direction of the member body unit 26, the +X-side fixing unit 27, and the −X-side fixing unit 28. The pair of reinforcement ribs 29 are each formed all over the member body unit 26, the +X-side fixing unit 27, and the −X-side fixing unit 28 along the X direction and improve the strength of the foot member 25a.

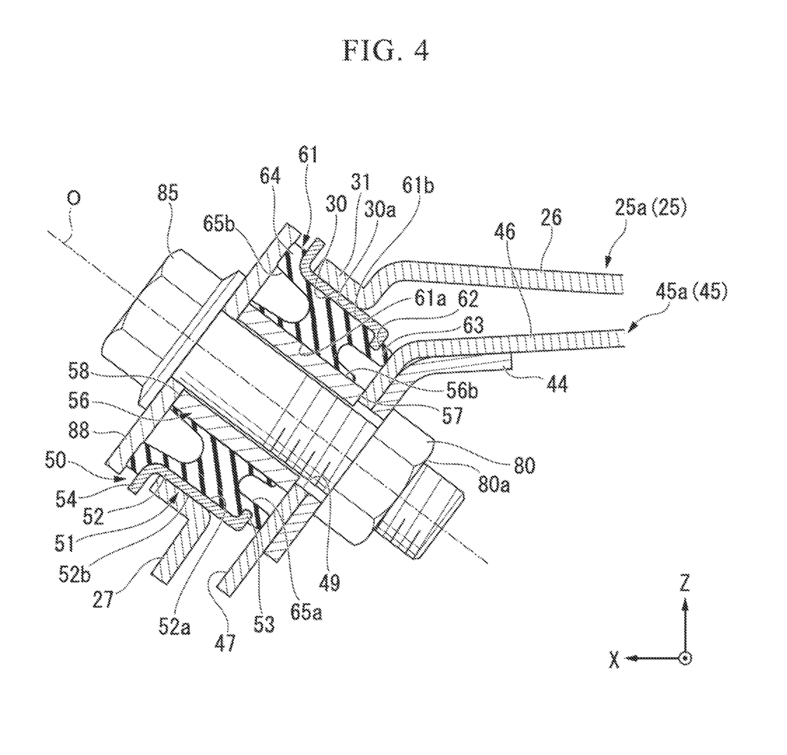

FIG. 4 is a cross-sectional view along an A-A line of FIG. 2.

As shown in FIG. 4, a through hole 30 is formed in the +X-side fixing unit 27 and the −X-side fixing unit 28 (refer to FIG. 3) of the foot member 25a.

Note that, the through hole 30 is formed in the −X-side fixing unit 28 in a similar way to the +X-side fixing unit 27. Accordingly, in the following description, the through hole 30 of the +X-side fixing unit 27 is described, and a detailed description of the through hole 30 (refer to FIG. 3) of the −X-side fixing unit 28 is omitted.

The through hole 30 of the +X-side fixing unit 27 is formed in a substantially circular shape in a view from the normal direction of the +X-side fixing unit 27. The edge portion of the through hole 30 of the +X-side fixing unit 27 is configured to be an annular section 31 provided to stand in the (+X, +Z) direction over the whole circumference. The elastic support body 50 described below is press-fitted in the annular section 31. The elastic support body 50 is joined to an inner peripheral surface 30a of the through hole 30 of the +X-side fixing unit 27.

As shown in FIG. 3, one of the pair of slide mechanisms 40a, 40b is provided at a position corresponding to each of the pair of foot members 25a, 25b.

Note that, one of the pair of slide mechanisms 40a, 40b is formed in substantially the same shape as that of the other. Accordingly, in the following description, the slide mechanism 40a provided on the +Y side is described, and a detailed description of the slide mechanism 40b provided on the −Y side is omitted.

The lower rail 41a extending in the X direction is fixed to the vehicle body floor 3 by a bolt (not shown) or the like, at a position corresponding to the foot member 25a. The lower rail 41a is formed in substantially a U shape opening on the +Z side in a view from the X direction and has a groove section 42 extending in the X direction.

### (Slide Adjuster)

Similar to the foot member 25a, the slide adjuster 45a is a member formed of, for example, a metal such as iron and is formed by press working. The slide adjuster 45a is provided on the +Z side of the lower rail 41a. The slide adjuster 45a is supported slidably in the X direction along the groove section 42 of the lower rail 41a, relative to the lower rail 41a.

The slide adjuster 45a is formed so as to face the foot member 25a. The surface on the +Z side of the slide adjuster 45a is formed in a shape corresponding to the surface on the −Z side of the foot member 25a.

Specifically, the slide adjuster 45a is formed in substantially an isosceles trapezoid shape in a view from the Y direction, by an adjuster body unit 46 extending in the X direction corresponding to the member body unit 26 of the foot member 25a, a +X-side mount unit 47 corresponding to the +X-side fixing unit 27 of the foot member 25a, and a −X-side mount unit 48 corresponding to the −X-side fixing unit 28 of the foot member 25a.

As shown in FIG. 4, a through hole 49 is formed in the +X-side mount unit 47. A nut 80 is provided on the −Z side of the through hole 49 via a reinforcement plate 44.

Note that, as shown in FIG. 3, the through hole 49 and the nut 80 (refer to FIG. 2) are provided in the −X-side mount unit 48 in a similar way to the +X-side mount unit 47. Accordingly, in the following description, the through hole 49 and the nut 80 of the +X-side mount unit 47 are described, and a detailed description of the through hole 49 and the nut 80 of the -X-side mount unit 48 is omitted.

As shown in FIG. 4, the inner form of the through hole 49 of the +X-side mount unit 47 is substantially circular in a view from the normal direction of the +X-side mount unit 47. The through hole 49 is formed substantially concentrically with the through hole 30 of the +X-side fixing unit 27. The through holes are formed such that the diameter of the through hole 49 of the +X-side mount unit 47 is smaller than the diameter of the through hole 30 of the +X-side fixing unit 27.

The nut 80 is, for example, a weld nut and is fixed to the reinforcement plate 44 at the −Z side of the through hole 49, for example, by welding. The nut 80 is welded such that a female screw section 80a is substantially concentric with the through hole 30 of the +X-side fixing unit 27 and the through hole 49 of the +X-side mount unit 47. A bolt 85 (fastening member) is screwed into the nut 80. The foot member 25a is fastened and fixed to the slide adjuster 45a via the elastic support body 50 described below.

### (Elastic Support Body)

The elastic support body 50 is interposed between the foot member 25 and the slide adjuster 45 and elastically supports the seat 10 (refer to FIG. 1).

As shown in FIG. 3, one of the elastic support bodies 50 of the present embodiment is provided at each of a position on the +X side and between the foot member 25a and the slide adjuster 45a, and a position on the −X side and between the foot member 25a and the slide adjuster 45a. One of the elastic support bodies 50 is provided at each of a position on the +X side and between the foot member 25b and the slide adjuster 45b, and a position on the −X side and between the foot member 25b and the slide adjuster 45b. That is, in the seat support mechanism 20 that supports the right seat 11 and the center seat 12, a total of four elastic support bodies 50 are provided between the pair of foot members 25a, 25b and the pair of slide adjusters 45a, 45b.

Note that, four elastic support bodies 50 are formed to be identical. Accordingly, in the following description, the elastic support body 50 interposed on the +X side and between the foot member 25a and the slide adjuster 45a of the +Y side is described, and a detailed description of the other elastic support bodies 50 is omitted.

As shown in FIG. 4, the elastic support body 50 is a substantially tube-shaped member and has an outer tube member 51, an inner tube member 56, and an elastic body 61. Hereinafter, each of the component parts of the elastic support body 50 is described. Note that, in the following description, the central axis of the elastic support body 50 is described as an axis line O.

### (Outer Tube Member)

The outer tube member 51 is a member formed of, for example, a metal such as iron and includes a tube body unit 52 formed in a substantially cylindrical shape. The tube body unit 52 is formed so as to have an outer diameter which is slightly greater than the inner diameter of the through hole 30 formed in the +X-side fixing unit 27 of the foot member 25a. Thereby, the outer tube member 51 is press-fitted in the annular section 31 of the +X-side fixing unit 27, and it is possible to join the inner peripheral surface 30a of the through hole 30 of the +X-side fixing unit 27 and an outer peripheral surface 52b of the tube body unit 52 of the outer tube member 51.

An end portion of the tube body unit 52 on the slide adjuster 45a side (hereinafter, referred to as “(−X, −Z) side”) in the axis line O direction is formed to be an inward flange section 53 that projects inwardly in the radial direction of the tube body unit 52. The inward flange section 53 fits into a fixing groove 62 of an elastic body 61 described below and fixes the outer tube member 51 to the elastic body 61.

An end portion of the tube body unit 52 on the opposite side of the slide adjuster 45a side (hereinafter, referred to as “(+X, +Z) side”) is formed to be an outward flange section 54 that projects outwardly in the radial direction of the tube body unit 52. The outward flange section 54 is formed so as to have an outer diameter which is greater than the inner diameter of the through hole 30 formed in the +X-side fixing unit 27 of the foot member 25a and the outer diameter of the annular section 31.

Thereby, for example, when an impact is applied to the seat 10 (refer to FIG. 1), and the foot member 25a moves in a direction away from the slide adjuster 45a along the axis line O, the outward flange section 54 of the outer tube member 51 and the annular section 31 of the foot member 25a interfere. Accordingly, it is possible to prevent the foot member 25a from detaching from the outer tube member 51.

### (Inner Tube Member)

The inner tube member 56 is, similarly to the outer tube member 51, a member formed of, for example, a metal such as iron and is formed in a substantially cylindrical shape.

The inner tube member 56 is formed so as to have an outer diameter which is greater than the inner diameter of the through hole 49 formed in the +X-side mount unit 47 of the slide adjuster 45a. Thereby, when the inner tube member 56 and the slide adjuster 45a are arranged such that the central axis of the inner tube member 56 (that is, axis line O) coincides with the central axis of the through hole 49 of the slide adjuster 45a, an end portion 57 (one end portion in the axis line direction) on the (−X, −Z) side of the inner tube member 56 comes into contact with the +X-side mount unit 47 of the slide adjuster 45a.

The inner tube member 56 is formed to have an inner diameter such that the bolt 85 for fastening the elastic support body 50 to the slide adjuster 45a can be inserted into the inner tube member 56. An end portion 58 (the other end portion in the axis line direction) on the (+X, +Z) side of the inner tube member 56 is in contact with a washer 88 (flange unit) described below.

### (Elastic Body)

The elastic body 61 is, for example, formed in a substantially tube shape by a rubber member such as an ethylene-propylene-diene rubber having durability and heat durability.

The elastic body 61 is formed to have an inner diameter which is slightly smaller than the outer diameter of the inner tube member 56. An inner peripheral surface 61a of the elastic body 61 is joined to an outer peripheral surface 56b of the inner tube member 56, for example, by thermal welding.

The elastic body 61 is formed to have an outer diameter which is greater than the inner diameter of the outer tube member 51. The fixing groove 62 is formed over the whole circumference in an outer peripheral surface 61b on the (−X, −Z) side of the elastic body 61. The inward flange section 53 of the outer tube member 51 is arranged within the fixing groove 62. Thereby, the elastic body 61 is fixed in contact with an inner peripheral surface 52a of the outer tube member 51 and is interposed between the outer tube member 51 and the inner tube member 56.

A flange section 64 that projects more outwardly than the tube body unit 52 of the outer tube member 51 in a view from the axis line O direction is formed at an end portion on the (+X, +Z) side of the elastic body 61. The flange section 64 is formed over the whole circumference of the elastic body 61 and is arranged between the outward flange section 54 of the outer tube member 51 and the washer 88.

Thereby, even when vibration is input from the vehicle body floor 3, and the elastic body 61 stretches along the axis line O direction, it is possible to prevent the outer tube member 51 and the washer 88 each formed of a metal from directly coming into contact with each other. Accordingly, the elastic support body 50 can provide good vibration isolation property.

An end portion 63 on the (−X, −Z) side of the elastic body 61 is arranged on the (−X, −Z) side of the inward flange section 53 of the outer tube member 51, and between the inward flange section 53 of the outer tube member 51 and the +X-side mount unit 47 of the slide adjuster 45a.

Thereby, even when vibration is input from the vehicle body floor 3, and the elastic body 61 stretches along the axis line O direction, it is possible to prevent the outer tube member 51 and the slide adjuster 45a each formed of a metal from directly coming into contact with each other. Accordingly, the elastic support body 50 can provide good vibration isolation property.

One of both end surfaces in the axis line O direction of the elastic body 61 is formed to be each of concave sections 65a, 65b concaved in the axis line O direction over the whole circumference around the axis line O. Thereby, the elastic body 61 is elastically deformable in a shear direction along the axis line O. Therefore, it is possible to ensure durability compared to a case where the elastic body 61 is elastically deformed in a compressive direction, and also to prevent vibration from transmitting from the vehicle body floor 3 (refer to FIG. 1) to the seat 10.

Note that, the distance between a bottom portion of the concave section 65a and a bottom portion of the concave section 65b (corresponding to a thickness in the shear direction of the elastic body 61) is set to a predetermined distance depending on vibration characteristics input from the vehicle body floor 3 or the like.

In the elastic support body 50 formed as described above, the tube body unit 52 of the outer tube member 51 is press-fitted in the annular section 31 in the +X-side fixing unit 27 of the foot member 25a, and the inner peripheral surface 30a of the through hole 30 and the outer peripheral surface 52b of the outer tube member 51 are joined to each other. Thereby, the +X-side fixing unit 27 of the foot member 25a is fixed at a more inward position than both end portions in the axis line O direction of the elastic support body 50.

In addition, the foot member 25a is fixed to the slide adjuster 45a via the elastic support body 50 by inserting the bolt 85 via the washer 88 into the inner tube member 56 of the elastic support body 50 and screwing the bolt 85 into the nut 80 of the +X-side mount unit 47. At this time, the end portion 57 on the (−X, −Z) side of the inner tube member 56 comes into contact with the +X-side mount unit 47 of the slide adjuster 45a. Thereby, a sufficient axial force can be obtained when the bolt 85 is screwed into the nut 80. Therefore, the foot member 25a and the elastic support body 50 are securely fastened and fixed to the slide adjuster 45a.

The washer 88 arranged at the end portion 58 on the (+X, +Z) side of the inner tube member 56 is formed to have a diameter which is greater than the inner diameter of the through hole 30 of the foot member 25a.

For example, when a great impact is applied to the seat 10 (refer to FIG. 1) toward the +X side, and the joint between the foot member 25a and the elastic support body 50 is released, the foot member 25a moves along the axis line O.

However, the washer 88 which is greater than the inner diameter of the through hole 30 is provided, and thereby, when the foot member 25a moves along the axis line O, the washer 88 and the annular section 31 formed at the edge portion of the through hole 30 of the slide adjuster 45a interfere. Accordingly, since the movement of the foot member 25a toward the (+X, +Z) side is restricted, and it is possible to prevent the foot member 25a from being detached from the outer tube member 51, it is possible to prevent the foot member 25a and the slide adjuster 45a from separating from each other.

Moreover, in the present embodiment, before the washer 88 and the annular section 31 of the slide adjuster 45a interfere, the outward flange section 54 of the outer tube member 51 and the annular section 31 of the foot member 25a interfere. Accordingly, it is possible to reliably prevent the foot member 25a from becoming detached from the outer tube member 51.

### (Operation of Seat Elastic Support Structure)

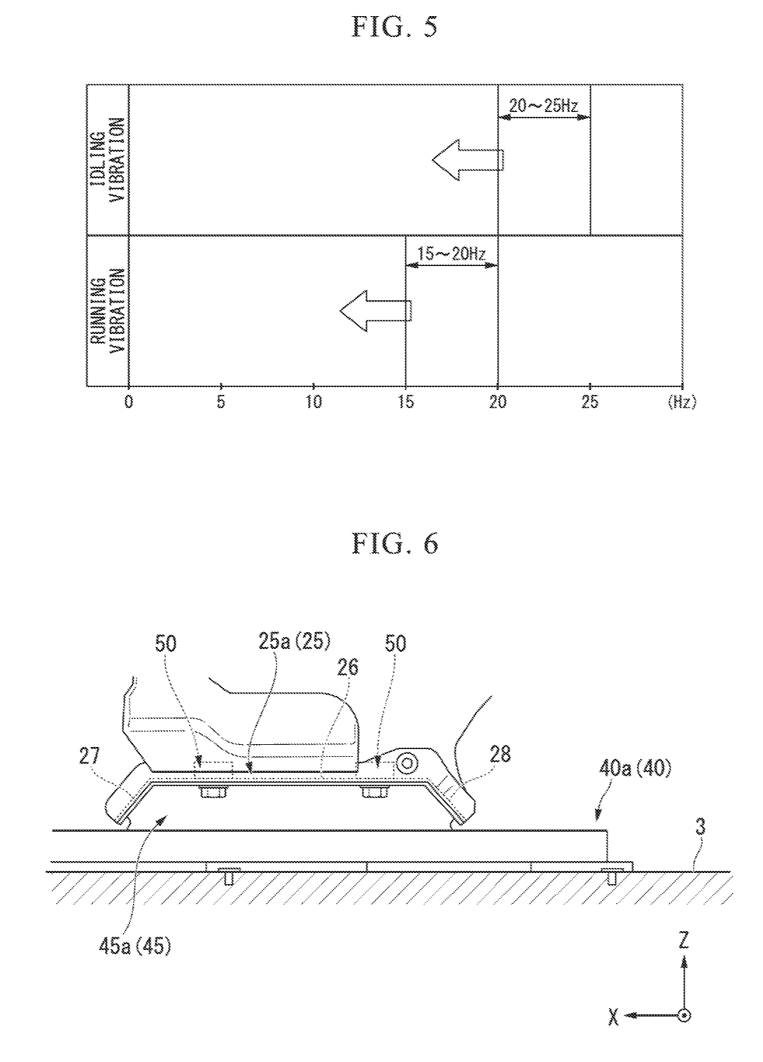

FIG. 5 is an explanation drawing of frequencies of a variety of vibration occurring in a vehicle.

Hereinafter, the operation of the elastic support structure according to the embodiment is described with reference to FIG. 5. Note that, for the reference numeral of each component in the following description, refer to FIG. 1 to FIG. 4.

Vibration that influences the seat 10 includes idling vibration input from an engine in an idling state during stopping of the vehicle 1 and running vibration input from a road surface or the like during running of the vehicle 1.

As shown in FIG. 5, idling vibration is vibration mainly in the front-rear direction of the seat backs 11b, 12b, and the frequency is, for example, about 20 to 25 Hz corresponding to an idling set rotation frequency of the engine. In addition, it is generally known that running vibration is vibration mainly in the right-left direction of the seat 10, and the frequency is, for example, about 15 to 20 Hz caused by a suspension resonance frequency or a vehicle body resonance frequency.

When the seat 10 is supported by the vehicle body floor 3 such that the eigenfrequency of the seat 10 is close to the frequency of idling vibration and the frequency of running vibration, the ride quality is degraded due to resonance. In addition, when the seat 10 is supported by the vehicle body floor 3 in a state where the support stiffness of the seat 10 is enhanced such that the eigenfrequency of the seat 10 is higher than the frequency of idling vibration and the frequency of running vibration, resonance can be avoided. However, since the seat 10 vibrates in phase with the vehicle body, the vibration reduction effect is low.

On the other hand, according to the elastic support structure of the seat 10 in which the elastic support body 50 is interposed between the slide adjusters 45a, 45b and the foot members 25a, 25b, the seat 10 is elastically supported by the vehicle body floor 3, and the eigenfrequency of the seat 10 is lower than the frequency of idling vibration and the frequency of running vibration (refer to the arrows in FIG. 5). Accordingly, the resonance between the frequency of idling vibration and the frequency of running vibration, and the eigenfrequency of the seat 10 is avoided, and the seat 10 vibrates in opposite phase with the vehicle body. Therefore, vibration is drastically reduced, and good ride quality of the vehicle 1 is ensured.

### (Advantages)

According to the present embodiment, the through hole 30 of the foot member 25 and the outer peripheral surface 52b of the outer tube member 51 are joined to each other, and thereby it is possible to fix the foot member 25 at a more inward position than both end portions in the axis line O direction of the elastic support body 50. Thus, unlike the related art in which one of both end portions in the axis line O direction of the elastic support body 50 is joined to the floor member and the other of both end portions is joined to the seat member, the position of the seat 10 can be set without being restricted by the length in the axis line O direction of the elastic support body 50. Accordingly, it is possible to prevent the position of the seat 10 from becoming high, and therefore the layout flexibility of the seat 10 can be ensured.

In addition, since the inner tube member 56 is fastened to the slide adjuster 45 by the bolt 85, it is possible to fix the elastic support body 50 to the slide adjuster 45 with a simple structure. In addition, the bolt 85 is provided radially inside the inner tube member 56, and thereby it is possible to prevent the inner tube member 56 from increasing in size radially outwardly, compared to a case where the bolt 85 is provided radially outwardly of the inner tube member 56. Accordingly, it is possible to avoid a case in which the elastic support body 50 is increased in size, and therefore the layout flexibility of the seat 10 can be further ensured.

Note that, the technical scope of the present invention is not limited to the above-described embodiments and a variety of modifications can be made to the above-described embodiments without departing from the scope of the present invention.

In the embodiment, the elastic support body 50 is interposed on the +X side and the −X side of the slide adjusters 45a, 45b and the foot members 25a, 25b, and the seat 10 is elastically supported by a total of four elastic support bodies 50.

On the other hand, for example, by interposing the elastic support body 50 only on the +X side or only on the −X side of the slide adjusters 45a, 45b and the foot members 25a, 25b, or by interposing the elastic support body 50 only on the +Y side or only on the −Y side, the seat 10 may be elastically supported by a total of two elastic support bodies 50.

Alternatively, by providing the elastic support body 50 at one of connection points of the slide adjusters 45a, 45b and the foot members 25a, 25b, the seat 10 may be supported.

FIG. 6 is an explanation drawing of another layout example of an elastic support body 50.

In the embodiment, the elastic support body 50 is provided at the +X-side fixing unit 27 and the −X-side fixing unit 28 of the foot member 25 (refer to FIG. 2). On the other hand, for example, as shown in FIG. 6, the elastic support body 50 may be provided on both sides interposing the center in the X direction of the member body unit 26 of the foot member 25.

Alternatively, the elastic support body 50 may be provided only on the +X side or only on the −X side of both sides interposing the center in the X direction of the member body unit 26 of the foot member 25. Moreover, the elastic support body 50 may be provided on the foot member 25 in a configuration in which the layout of the elastic support body 50 in the embodiment and the another layout example of the elastic support body 50 shown in FIG. 6 are arbitrarily combined.

In the embodiment, the outer tube member 51 of the elastic support body 50 is joined to the through hole 30 of the foot member 25, and the inner tube member 56 of the elastic support body 50 is fastened and fixed to the slide adjuster 45. Thereby, the elastic support body 50 is interposed between the foot member 25 and the slide adjuster 45.

On the other hand, a through hole may be provided in the slide adjuster 45, the outer tube member 51 of the elastic support body 50 may be joined to the through hole of the slide adjuster 45, and the inner tube member 56 of the elastic support body 50 may be fastened and fixed to the foot member 25. Thereby, the elastic support body 50 may be interposed between the foot member 25 and the slide adjuster 45.

The embodiment is described using an example in which the elastic support structure is applied to the second row seats 10 in the minivan-type vehicle 1. However, the application of the elastic support structure of the seat 10 in the embodiment is not limited to the second row seats 10 in the minivan-type vehicle 1. For example, the elastic support structure of the seat 10 in the embodiment can be applied to third row seats in the minivan-type vehicle 1, a driver seat in a sedan-type vehicle, a passenger seat, or the like.

In the embodiment, the washer 88 is arranged at the end portion 58 on the (+X, +Z) side of the inner tube member 56 and functions as a stopper which restricts the movement of the foot member 25 toward the (+X, +Z) side. On the other hand, for example, a flange unit which is greater than the inner diameter of the through hole 30 may be integrally formed at the end portion 58 on the (+X, +Z) side of the inner tube member 56 such that the flange unit may function as a stopper.

In the embodiment, the inner form of the through hole 30 of the foot member 25 is set to a substantially circular shape, and the outer tube member 51 of the elastic support body 50 is formed in a substantially cylindrical shape corresponding to the shape of the through hole 30. On the other hand, the inner form of the through hole 30 of the foot member 25 may be set to a substantially rectangular shape, and the outer tube member 51 of the elastic support body 50 may be formed in a substantially rectangular cylindrical shape corresponding to the shape of the through hole 30.

In the embodiment, the outward flange section 54 is provided at the end portion on the (+X, +Z) side of the outer tube member 51. However, the outward flange section 54 of the outer tube member 51 may not be provided.

However, according to the present embodiment, the outward flange section 54 of the outer tube member 51 and the washer 88 arranged on the (+X, +Z) side of the outward flange section 54 function as a stopper which restricts the movement of the foot member 25 toward the (+X, +Z) side. Accordingly, from the viewpoint that the movement of the foot member 25 toward the (+X, +Z) side can be reliably restricted, the embodiment is superior to a case where the outward flange section 54 of the outer tube member 51 is not provided and only the washer 88 functions as a stopper.

The embodiment is described using an example of idling vibration and running vibration as the vibration which can be avoided by using the elastic support structure of the seat 10 of the present invention; however, the avoidable vibration is not limited to idling vibration and running vibration.

### DESCRIPTION OF THE REFERENCE SYMBOLS

10: SEAT

25, 25a, 25b: FOOT MEMBER (SEAT MEMBER)

30: THROUGH HOLE

30a: INNER PERIPHERAL SURFACE OF THROUGH HOLE

45, 45a, 45b: SLIDE ADJUSTER (FLOOR MEMBER)

50: ELASTIC SUPPORT BODY

51: OUTER TUBE MEMBER

52b: OUTER PERIPHERAL SURFACE OF OUTER TUBE MEMBER

56: INNER TUBE MEMBER

57: END PORTION (ONE END PORTION IN AXIS LINE DIRECTION OF INNER TUBE MEMBER)

58: END PORTION (THE OTHER END PORTION IN AXIS LINE

DIRECTION OF INNER TUBE MEMBER)

61: ELASTIC BODY

85: BOLT (FASTENING MEMBER)

88: WASHER (FLANGE UNIT) O: AXIS LINE

1. A seat elastic support structure comprising:
a floor member;
a seat member facing the floor member; and
an elastic support body interposed between the floor member and the seat member and having an outer tube member, an inner tube member arranged inside the outer tube member, and an elastic body interposed between the outer tube member and the inner tube member, wherein
one end portion in an axis line direction of the inner tube member is in contact with a first member which is any one of the floor member and the seat member,
a second member which is the other of the floor member and the seat member is provided with a through hole into which the outer tube member is inserted, an inner peripheral surface of the through hole and an outer peripheral surface of the outer tube member are joined to each other,
the other end portion in the axis line direction of the outer tube member is an outward flange section that projects outwardly in a radial direction of the outer tube member, and
an outer diameter of the outward flange section is greater than an inner diameter of the through hole.

2. The seat elastic support structure according to claim 1, wherein
a fastening member used to fasten the inner tube member to the first member is provided radially inside the inner tube member.

3. The seat elastic support structure according to claim 1, wherein
the other end portion in the axis line direction of the inner tube member is provided with a flange unit which is greater than an inner diameter of the through hole.

4. The seat elastic support structure according to claim 2, wherein
the other end portion in the axis line direction of the inner tube member is provided with a flange unit which is greater than an inner diameter of the through hole.
